(19) United States
(12) Patent Application Publication
(10) Pub. No.: US 2022/0057916 A1
(43) Pub. Date: Feb. 24, 2022

(54) METHOD AND APPARATUS FOR ORGANIZING AND INVOKING COMMANDS FOR A COMPUTING DEVICE

(71) Applicant: SHANGHAI YU WA INFORMATION TECHNOLOGY CO. LTD., Shanghai (CN)

(72) Inventor: Jun WU, Shanghai (CN)

(73) Assignee: SHANGHAI YU WA INFORMATION TECHNOLOGY CO. LTD., Shanghai (CN)

(21) Appl. No.: 17/415,142

(22) PCT Filed: Dec. 19, 2018
(86) PCT No.: PCT/CN2018/122156

§ 371 Date: Jun. 17, 2021

(51) Int. Cl. G06F 3/0481; G06F 3/0482; G06F 3/0486; G06F 3/0488

(52) U.S. Cl. CPC G06F 3/04815; G06F 3/04817; G06F 3/0488; G06F 3/0486; G06F 3/0482

(57) ABSTRACT

Apparatus and method for operating a computing device are disclosed. The method comprises associating a plurality of actionable items to a plurality of locations on a surface of an imaginary three dimensional (3D) object, determining a subset of the locations to visible in a projection of the imaginary 3D object onto a two dimensional (2D) view based on a relative orientation, a relative position, or both of the imaginary 3D object with respect to the 2D view and presenting on a display device a subset of the plurality of actionable items associated with the subset of the locations.

### TECHNICAL FIELD

The disclosure herein relates to user interfaces for a computing device and, in particular, to operating a computing device using an interactive graphical user interface.

### BACKGROUND

Computing devices, such as computers or mobile devices, have become ubiquitous in today's world and are capable of performing a wide variety of functions. A computing device may install many applications and the number of applications installed on a computing device is growing rapidly. A negative side effect is that it is increasingly difficult for a user of a computing device to organize, launch, and use the various installed applications quickly and easily. Moreover, a user may store many informational items in a computer device. For example, a folder may include hundreds or thousands of files or a user may store hundreds of contact names in a contact list. This makes it very difficult for the user to quickly locate one particular information item. Although conventional user interfaces can be used to access the various functionalities and content available on a computing device, such user interfaces are not well suited for presenting information that is not necessarily alphabetically organized. Furthermore, conventional menus or lists that have been used to represent the available items or options on a computing device have extremely limited visual extensibility.

### SUMMARY

Disclosed herein is a method implemented at least in part by a computing device, the method may comprise: associating a plurality of actionable items to a plurality of locations on a surface of an imaginary three dimensional (3D) object, determining a subset of the locations to be visible in a projection of the imaginary 3D object onto a two dimensional (2D) view based on a relative orientation, a relative position, or both of the imaginary 3D object with respect to the 2D view and presenting on a display device a subset of the plurality of actionable items associated with the subset of the locations.

According to an embodiment, the method further comprises receiving a user action to spin the imaginary 3D object and rotating the imaginary 3D object to bring one or more of the plurality of actionable items that do not belong to the subset of the plurality of actionable items into the 2D view.

According to an embodiment, the display device is a touch screen of a mobile device.

According to an embodiment, the user action is a swipe of a finger on the touch screen.

According to an embodiment, the method further comprises according to a configuration setting, rotating the imaginary 3D object to bring one or more of the plurality of actionable items that do not belong to the subset of the actionable item into the 2D view.

According to an embodiment, the method further comprises receiving a user action on an actionable item of the plurality of actionable item and launching an information session associated with the actionable item, wherein the information session is one of an opened website, an opened detailed page for a contact, a launched application, an opened file, an opened folder and a launched application module.

According to an embodiment, the display device is a touch screen of a mobile device, and the user action is a tap or a double tap on the actionable item.

According to an embodiment, the method further comprises presenting a home button for returning to showing the 2D view.

According to an embodiment, the method further comprises launching a plurality of information sessions associated with select actionable items sharing a common characteristic with the actionable item receiving the user action, and presenting tabs to represent the plurality of information sessions, wherein the common characteristic is a configurable setting.

According to an embodiment, the method further comprises receiving a user action to drag and drop an actionable item and adjusting a position of the actionable item dragged and dropped in the user action to a new position.

According to an embodiment, the new position is on the 2D view and in close proximity to one or more actionable items sharing a common characteristic of the actionable item dragged and dropped in the user action.

According to an embodiment, the new position is outside of the 2D view.

According to an embodiment, the display device is a touch screen of a mobile device and the user action is pressing and holding a finger to move the actionable item.

According to an embodiment, the display device is a monitor for a computing device and the user action is received from a mouse coupled to the computing device.

According to an embodiment, the method further comprises grouping at least some of the plurality of actionable items to form a group of actionable items and positioning the group of actionable items in one region of the imaginary 3D object.

According to an embodiment, the 2D view is a full perspective view of the imaginary 3D object looking from a view point outside of the imaginary 3D object.

According to an embodiment, the 2D view is a partial perspective view of the imaginary 3D object looking from a view point outside of the imaginary 3D object.

According to an embodiment, the 2D view is a perspective view of the imaginary 3D object looking from a view point inside of the imaginary 3D object.

According to an embodiment, the method further comprises: presenting an activation button on the display device, receiving a user action to activate the activation button and presenting one or more menu items in response to the user action.

Disclosed herein is a computing device comprising a processor and a memory, the memory storing computer-executable instructions that when executed by the processor cause the processor to perform a method, the method comprising: associating a plurality of actionable items to a plurality of locations on a surface of an imaginary three dimensional (3D) object, determining a subset of the locations to be visible in a projection of the imaginary 3D object onto a two dimensional (2D) view based on a relative orientation, a relative position, or both of the imaginary 3D object with respect to the 2D view, and presenting on a display device a subset of the plurality of actionable items associated with the subset of the locations

According to an embodiment, the method further comprises: receiving a user action to spin the imaginary 3D object and rotating the imaginary 3D object to bring one or more of the plurality of actionable items that do not belong to the subset of the plurality of actionable item into the 2D view.

According to an embodiment, the computing device is a mobile device and the display device is a touch screen of the mobile device.

According to an embodiment, the user action is a swipe of a finger on the touch screen.

According to an embodiment, the method further comprises, according to a configuration setting, rotating the imaginary 3D object to bring one or more of the plurality of actionable items that do not belong to the subset of the plurality of actionable items into the 2D view.

According to an embodiment, the method further comprises: receiving a user action on an actionable item of the plurality of actionable items and launching an information session associated with the actionable item, wherein the information session is one of an opened website, an opened detailed page for a contact, a launched application, an opened file, an opened folder and a launched application module.

According to an embodiment, the computing device is a mobile device, the display device is a touch screen of the mobile device, and the user action is a tap or a double tap on the actionable item.

According to an embodiment, the method further comprises presenting a home button for returning to showing the 2D view.

According to an embodiment, the method further comprises launching a plurality of information sessions associated with select actionable items sharing a common characteristic with the actionable item receiving the user action, and presenting tabs to represent the plurality of information sessions, wherein the common characteristic is a configurable setting.

According to an embodiment, method further comprises: receiving a user action to drag and drop an actionable item and adjusting a position of the actionable item dragged and dropped in the user action to a new position.

According to an embodiment, the new position is on the 2D view and in close proximity to one or more actionable items sharing a common characteristic of the actionable item dragged and dropped in the user action.

According to an embodiment, the new position is outside of the 2D view.

According to an embodiment, the computing device is a mobile device, the display device is a touch screen of the mobile device and the user action is pressing and holding a finger to move the actionable item.

According to an embodiment, the display device is a monitor and the computing device is connected to a mouse to receive user inputs.

According to an embodiment, wherein the method further comprises: grouping at least some of the plurality of actionable items to form a group of actionable items and positioning the group of actionable items in one region of the imaginary 3D object.

According to an embodiment, the 2D view is a full perspective view of the imaginary 3D object looking from a view point outside of the imaginary 3D object.

According to an embodiment, the 2D view is a partial perspective view of the imaginary 3D object looking from a view point outside of the imaginary 3D object.

According to an embodiment, the 2D view is a perspective view of the imaginary 3D object looking from a view point inside of the imaginary 3D object.

According to an embodiment, the method further comprises: presenting an activation button on the display device, receiving a user action to activate the activation button and presenting one or more menu items in response to the user action.

Discloses herein is a non-transitory computer readable storage media encoded with software comprising computer executable instructions and when the software is executed by a computer processor cause the computer processor to perform a method, the method comprising: associating a plurality of actionable items to a plurality of locations on a surface of an imaginary three dimensional (3D) object, determining a subset of the locations to be visible in a projection of the imaginary 3D object onto a two dimensional (2D) view based on a relative orientation, a relative position, or both of the imaginary 3D object with respect to the 2D view, and presenting on a display device a subset of the plurality of actionable items associated with the subset of the locations.

According to an embodiment, the method further comprises: receiving a user action to spin the imaginary 3D object and rotating the imaginary 3D object to bring one or more of the plurality of actionable items that do not belong to the subset of the plurality of actionable item into the 2D view.

According to an embodiment, the method further comprises, according to a configuration setting, rotating the imaginary 3D object to bring one or more of the plurality of actionable items that do not belong to the subset of the plurality of actionable items into the 2D view.

According to an embodiment, the method further comprises: receiving a user action on an actionable item of the plurality of actionable items and launching an information session associated with the actionable item, wherein the information session is one of an opened website, an opened detailed page for a contact, a launched application, an opened file, an opened folder and a launched application module.

According to an embodiment, the method further comprises: receiving a user action to drag and drop an actionable item and adjusting a position of the actionable item dragged and dropped in the user action to a new position.

According to an embodiment, the method further comprises: grouping at least some of the plurality of actionable items to form a group of actionable items and positioning the group of actionable items in one region of the imaginary 3D object.

### BRIEF DESCRIPTION OF THE DRAWINGS

FIG. 1A schematically shows a graphical user interface for a computing device, according to an embodiment.

FIG. 1B schematically shows a graphical user interface for a computing device, according to another embodiment.

FIG. 1C schematically shows a graphical user interface for a computing device, according to yet another embodiment.

FIG. 1D schematically shows the graphical user interface of FIG. 1C in a different operational state, according to an embodiment.

FIG. 2A schematically shows a graphical user interface for a computing device, according to another embodiment.

FIG. 2B schematically shows a graphical user interface for a computing device, according to another embodiment.

FIG. 2C schematically shows a graphical user interface for a computing device, according to yet another embodiment.

FIG. 2D schematically shows the graphical user interface of FIG. 2C in a different operational state, according to an embodiment.

FIG. 3A schematically shows a graphical user interface for a computing device, according to another embodiment.

FIG. 3B schematically shows a graphical user interface for a computing device, according to another embodiment.

FIG. 4A schematically shows a graphical user interface for a computing device, according to an embodiment.

FIG. 4B schematically shows a graphical user interface for a computing device, according to another embodiment.

FIG. 4C schematically shows a graphical user interface for a computing device, according to an embodiment.

FIG. 4D schematically shows a graphical user interface for a computing device, according to another embodiment.

FIG. 5A schematically shows a graphical user interface for a computing device, according to another embodiment.

FIG. 5B schematically shows a graphical user interface for a computing device, according to an embodiment.

FIG. 6A schematically shows a graphical user interface for a computing device, according to another embodiment.

FIG. 6B schematically shows a graphical user interface for a computing device, according to an embodiment.

FIG. 7A schematically shows a graphical user interface for a computing device, according to another embodiment.

FIG. 7B schematically shows a graphical user interface for a computing device, according to an embodiment.

FIG. 7C schematically shows a graphical user interface for a computing device, according to another embodiment.

FIG. 7D schematically shows a graphical user interface for a computing device, according to an embodiment.

FIG. 8 schematically shows a flowchart of an exemplary method for populating a graphical user interface of a computing device, according an embodiment.

FIG. 9 schematically shows a flowchart of an exemplary method for operating a computing device using a graphical user interface, according an embodiment.

FIG. 10 schematically shows an exemplary computing device with which any of the disclosed embodiments can be implemented.

### DETAILED DESCRIPTION

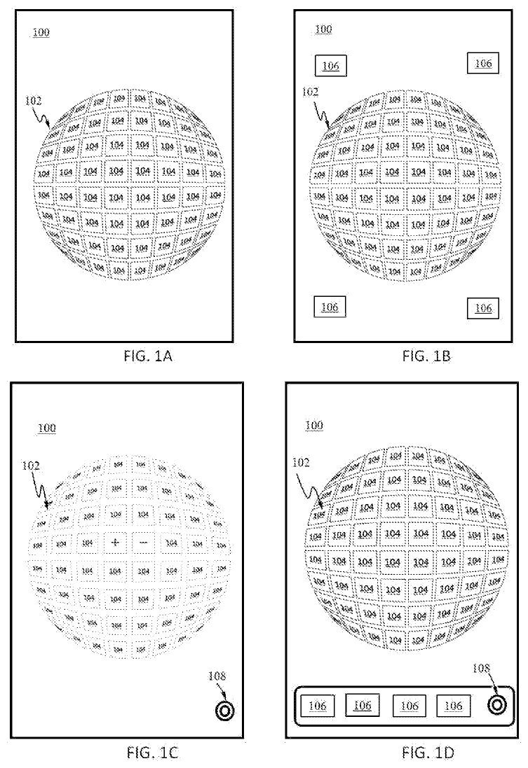

FIG. 1A is a schematic diagram of an exemplary graphical user interface 100 presented on a display device for a computing device. The display device may be, for example, a computer monitor, a television, a touch screen. In one or more embodiments, the graphical user interface 100 may be a graphical user interface for an application running on the computing device and may comprise a two-dimensional (2D) display pane 102. The display pane 102 may comprise a plurality of actionable items 104. The plurality of actionable items 104 may be commands, buttons, or actionable links associated with information items. The information items may be, for example, files (including text files and executable files) in a file folder, folders on a desktop or file folder, applications stalled on the computing device and arranged on a desk top, links to websites, menu items for a menu system, contacts from a contact list, etc. In one embodiment, the information items may be referred to as the information items underlying the actionable items.

In embodiments where the computing device uses a mouse as an input, the predefined commands, buttons or actionable links may be invoked by a single click, a double click, or any actions performed by a mouse connected to the computing device. In embodiments where the display device is a touch screen, the predetermined predefined commands, buttons or actionable links may be invoked by a single tap, a double tap, or any gestures of a finger on the touch screen. Unless otherwise specified, any clicks or other actions (e.g., holding a mouse button to drag an item on a user interface) that may be performed by a mouse in one embodiment may be implemented as taps or gestures (e.g., press and hold a finger to drag an item) on a touch screen in another embodiment.

In one embodiment, the plurality of actionable items 104 may be buttons. For example, the display pane 102 may be part of a menu system for an application and the actionable items may represent menu items for the application. A user may click on an actionable item 104 with a mouse (or tap on an actionable item 104 with a finger if the display device is on a touch screen), and an action associated with the clicked (or tapped) button may be performed.

In another embodiment, the plurality of actionable items 104 may be links. For example, the display pane 102 may be part of an application that implements Internet browser functionalities. The actionable items 104 may represent websites. For example, each actionable item 104 may be marked by text (e.g., XYZ Company website, XYZ.com, or just XYZ), icon (e.g., a logo for XYZ company), or both for a respective website. A user may click on an actionable item 104 with a mouse (or tap on an actionable item 104 with a finger if the display device is a touch screen), and the corresponding website may be opened.

In yet another embodiment, the plurality of actionable items 104 may represent applications. For example, the graphical user interface 100 may be a desktop for a computing device and the plurality of actionable items 104 may represent applications accessible from the desktop. In another example, the display pane 102 may be part of a file folder display and the actionable items 104 may represent files (or shortcuts for files) in the file folder. In these embodiments, each actionable item 104 may be marked by text (e.g., application or file name), icon (e.g., application or file icon), or both for a respective file or folder. A user may click on an actionable item 104 with a mouse (or tap on an actionable item 104 with a finger if the display device is a touch screen), and the corresponding file or folder may be opened (or launched if the file is an executable application).

In a further embodiment, the plurality of actionable items 104 may be links to informational items. For example, the display pane 102 may be part of an application (e.g., an email application, a phone application, a social network application) that stores a name or Identifier (“ID”) list (e.g., a contact list, a professional connection list). The actionable items 104 may represent detailed information for the individuals associated with the names or IDs. For example, each actionable item 104 may be marked by text (e.g., name or ID of an individual), icon (e.g., an image for the individual), or both for a respective name or ID. A user may click on an actionable item 104 with a mouse (or tap on an actionable item 104 with a finger if the display device is a touch screen), and a detailed information page for the corresponding name or ID may be opened.

In some embodiments, the plurality of actionable items 104 may comprise combinations of buttons (e.g., menu items for an applications), links (e.g., websites, detailed information pages, folders), and commands (e.g., file opening commands). For example, in one embodiment, some of the actionable items 104 may be buttons, some others may be links. In another embodiment, some of the actionable items 104 may be links and some others may be commands. Moreover, in some embodiments, at least some of the actionable items may be presented on transparent or translucent tiles on the display pane 102. Furthermore, in some embodiments, one of the plurality of actionable items 104 may implement an “add” function. For example, an actionable item 104 may be marked by a “+” (“plus”) sign to denote that it may be used to add more actionable items (e.g., to add link to a new website, to add a new name/ID to a list). In addition, one of the plurality of actionable items 104 may implement a “delete” function. For example, an actionable item 104 may be marked by a “−” (“minus”) sign to denote that it may be used to delete existing actionable items (e.g., to delete a link to a website, to delete a name/ID from a list).

In one or more embodiments, the two dimensional display pane 102 may be a two dimensional perspective view of a three dimensional (3D) object. The 3D object may have a set of actionable items 104 positioned on its surface and the plurality of actionable items 104 shown in the two dimensional display pane 102 may be a subset of the whole set of the actionable items 104 positioned on the surface of the three dimensional object that may be visible in the two dimensional display pane 102 based on a relative position, a relative orientation, or both. The 3D object may be an imaginary 3D object in that it is not a physical object but merely a data structure created based on computer operations (e.g., by software). For example, the 3D object and the 2D view may be created using a graphics application program interface (API), such as, but not limited to, WebGL or OpenGL, or using a graphics library built on top of the Web Graphics Library (WebGL) or Open Graphics Library (OpenGL), such as BABYLONJS, PLAYCANVAS, or THREE.JS.

In some embodiments, the view point to generate the 2D view may be changed by a user action. For example, on a touch screen, a user may press and hold one, two, or three fingers on the 2D view and move the 2D view's position on the graphical user interface 100.

In at least one embodiment, the actionable items 104 displayed on the two dimensional display pane 102 may change when the three dimensional object is spun. For example, the three dimensional object may only have a portion facing a view point and the perspective two dimensional view may be generated based on what falls into a view from this view point (e.g., using a camera facing the three dimensional object to capture what falls into the camera's view). Another portion of the three dimensional object may be on a side of the three dimensional object that is not facing the view point and the information items assigned to this portion of the three dimensional object do not appear in the two dimensional display pane 102. When the three dimensional object is spun, some portion of the three dimensional object that is not shown in the two dimensional display pane 102 previously may come into the two dimensional display pane 102 and the information items assigned to this portion of the three dimensional object may appear as some of the actionable items 104 now in the two dimensional display pane 102. At the same time, the spin of the three dimensional object may also cause some of the previously shown actionable items now out of the two dimensional display pane 102 and disappear from the graphical user interface 100.

In some embodiments, the actionable items covering the three dimensional object may have gaps therebetween. For example, the actionable items 104 may be displayed on the display pane 102 using tiles and neighboring tiles may have gaps between them. In various embodiments, the gaps may be transparent or translucent. In an embodiment where the gaps are transparent, the two dimensional display pane 102 may have a see-through visual effect. For example, the back of the tiles (which may be translucent or opaque) of at least some of the actionable items not facing the view point may be shown in the two dimensional display pane 102 as well as the background (e.g., an area of the graphical user interface 100 covered by the display pane 102). In addition to the gaps, in some embodiments, the tiles on which the actionable items are shown may also be transparent. In these embodiments, at least some of the actionable items not facing the view point may be shown in the two dimensional display pane 102.

As described herein, in various embodiments, the information session may be a website, a file, a detailed individual information page, an application on the computing device, a function of a menu system, etc. Furthermore, in one or more embodiments, the three dimensional object may have a continuous surface (e.g., a globe or ovoid). In at least one embodiment, the three dimensional object may be spun by a user action. For example, a drag of a mouse button (e.g., holding a button on the mouse and moving in a direction), a swipe of a figure (if the display device is a touch screen), or a drag of two fingers (on a touchpad of a laptop or a touch screen) may cause the three dimensional object to rotate about an axis. In one embodiment, the spin caused by a drag of a mouse button or a swipe may continue for a short time after the mouse button is released or the finger lifted after the swipe, and the spin caused by a drag of two fingers may stop when the fingers stop moving or be lifted from the touchpad or touch screen. The axis may be, for example, an axis that the continuous surface circled around, or an axis perpendicular to the direction of the user action. In one embodiment in which the three dimensional object is a globe, the tiles of actionable items may be placed with their icons or texts in latitudinal directions, and the rotation of the globe may be restricted to be about an axis through the north and south poles of the globe. In these embodiments, the two dimensional perspective view of the three dimensional object, hence the two dimensional display pane 102, may visually continuously change the actionable items 104 shown in the graphical user interface 100 when the three dimensional object is spun.

In some embodiments, the information items may be grouped into different groups according to criteria and each group of information item sharing one or more common characteristics may be assigned to one respective region of the three dimensional object. Therefore, the information items in one group may be positioned in close proximity of each other. For example, in one embodiment, the information items may be websites. In this embodiment, a plurality of news websites may be grouped together and assigned in one region of the three dimensional object, a plurality of social network websites may be grouped together and assigned to another region of the three dimensional object, a plurality of website in another language may be grouped together and assigned to yet another region of the three dimensional object. The display pane 102 may therefore show actionable items 104 for news websites in one area and actionable items for social network websites in another area. Thus, by finding one news website, other news websites may be located in the close proximity of this one news website. In another embodiment, the information items may be contacts from a contact list. A plurality of classmates may be grouped together and assigned to one region of the three dimensional object, a plurality of colleagues may be grouped together and assigned to another region of the three dimensional objects and a plurality of relatives may be grouped together and assigned to yet another region of the three dimensional objects. The display pane 102 may therefore show actionable items 104 for classmates in one area, actionable items 104 for colleagues in another area and actionable items for relatives in yet another area. Thus, by finding one classmate, colleague or relative, other classmates, colleague or relatives may be located in close proximity to the found one.

In some embodiments, by spinning the three dimensional objects, actionable items 104 for all groups of the information items be shown in the display pane 102. Accordingly, a user may locate the actionable item for a desired information item by spinning the three dimensional object to find the region for the group of information items that the desired information may belong to (e.g., find the news website region to locate a news website, find the classmates region to locate a classmate). The criteria for grouping the information items are numerous and not limited to the examples described herein. In different embodiments, different criteria or combination of the criteria may be implemented.

In addition to grouping the information items, thus affecting the positions of the corresponding actionable items 104 on the display pane 102. In one embodiment, the positions of the actionable items 104 may be adjusted by a user. For example, a user action may be received from a user to drag and drop (e.g., holding a button of a mouse or holding a finger on the touch screen) one or more actionable items 104 to arrange their positions (e.g., putting some websites the user frequently access together, putting some frequently contacted individuals together, etc.). Moreover, in at least one embodiment, one or more actionable items 104 may be placed on the graphical user interface outside of the display pane 102. For example, one or more frequently accessed websites, one or more frequently used individual contacts, one or more frequently invoked application or application modules, or combination thereof. In one embodiment, which one of the actionable items 104 may be placed outside of the display pane 102 may be determined according to a configuration setting (e.g., in a setting page). In addition, at least one or more of the actionable items 104 may be dragged out of the display pane 102 and placed at locations on the graphical user interface 100 determined by a user in response to user actions (e.g., using a mouse or a finger on a touch screen).

In various embodiments, the grouping and position information of the actionable items 104 may be preserved. When the graphical user interface 100 is displayed again, the actionable items 104 may be arranged according to the preserved grouping and position information. Because the three dimensional object may have a continuous surface, the position information may be relative position information. For example, how an actionable item 104 may be placed next to another actionable item 104 (e.g., to the left or right, on top of, or below, etc.). In one embodiment, the three dimensional object may be a globe and each group of actionable items may be assigned to one respective region of the globe, for example, a spherical lune, a spherical triangle, or a region of neighboring tiles (e.g., n by m tiles, n and m may be integers for latitude and longitude respectively).

In one or more embodiments, an application can be software installed on or available to a computing device. For example, an application can be an email client, web browser, web application, game, music software, or other installed, accessed, or downloaded software available on a computing device. In some examples, applications can be for providing games, news, social network access, sports information, purchasing information, entertainment, video, movies, television programs, internet access, music, text editors, books, document readers, tools, information, work utilities, organizers, contacts lists, maps, searching, calculators, and other content and functionality. Applications can also provide information, content, and functionality. Launching the application allows for a user to access the functionality, data, information, and content of the application. In some implementations, an application can be running in the background (e.g., in a stand-by state), and is displayed to the user in the foreground when launched. Launching the application can display screens or windows of the application to the user. In some implementations, a launched application can display a user interface of the application (e.g., the graphical user interface 100) that allows a user to use the application. In some implementations launching an application loads software instructions of the application into memory of a computing device. In another implementation an application can be accessed through a web browser or other internet tool. In some embodiments, functionalities of an application may be implemented in functional modules of the application. Moreover, a functional module may be installed by receiving updates to an installed application.

FIG. 1B is a schematic diagram of the exemplary graphical user interface 100 according to another embodiment. In addition to the exemplary display pane 102 with the plurality of actionable items 104 as shown in FIG. 1A and described herein, the graphical user interface 100 of FIG. 1B may comprise one or more menu items 106. The menu items may be actionable items that may be invoked. But in contrast to the actionable items 104, they don't have corresponding information items. Four menu items 106 are shown in FIG. 1B for illustration purpose but the actual number of menu items 106 in various embodiments may be as less as one and as many as the graphical user interface may accommodate (e.g., 5, 10, etc.). In some embodiments, each of the menu items 106 may be shown in text, icon, or both, and may be invoked by a predefined action or gesture, for example, a single click or a double click of a mouse (or a single tap or double tap with a finger if the display device is a touch screen).

In one or more embodiments, the menu items 106 may include selected ones of “search,” “history,” “help,” “settings,” “more,” etc. For example, a “search” menu may be used to invoke a search functionality to search one particular actionable item 104, or a setting for the application that presents the graphical user interface 100. In one embodiment, if a searched actionable item 104 is found, the three dimensional object may be rotated to display the searched actionable item 104 in a center position if it is not there already. Moreover, in one embodiment, the found actionable item 104 may be highlighted, for example, using a spot light, using a different icon, or a 3D shade to make the found actionable item 104 to be distinguishable from other actionable items 104. A “history” menu may be used to invoke a functionality to show the historically invoked actionable items, for example, recently visited websites, recently opened individual information pages, recently launched applications, recently opened files, etc. A “help” menu may be used to invoke a help page for the application that presents the graphical user interface 100. A “settings” menu may be used to invoke a settings page for the graphical user interface 100, the display pane 102, and/or any setting for the application that presents the graphical user interface 100. For example, one setting selection may be used to control the spin speed when a user action causes the three dimensional object to spin, another setting selection may be used to choose whether the three dimensional object is to set spin by default without user action (e.g., a spin by default mode), yet another setting selection may be used to set the spin speed in the spin by default mode, and yet another setting selection may be used to let a user to choose a theme of background from a plurality of options. And a “more” menu may be used to display more menu items not currently shown on the graphical user interface 100, for example, “Print” to send a current display to a printer, or an “Exit” menu to exist from the application that presents the graphical user interface 100.

FIG. 1C is a schematic diagram of an alternative embodiment of the graphical user interface 100. In comparison to FIG. 1B, the one or more menu items 106 may be replaced by a single activation button 108. The activation button 108 may be a special actionable item to display available menu items 106. In operation, for example, a user may click (or tap if the display device is a touch screen) on the activation button 108 and a menu bar may glide or slide open. One example is shown on FIG. 1D, which schematically shows the graphical user interface 100 of FIG. 1C in an operational state that a menu bar with the menu items 106 is displayed. In one embodiment, the menu bar may be retracted by a click (or a tap if the display device is a touch screen) on the activation button 108 when the menu bar is shown. Although the menu bar is shown as a straight bar in FIG. 1C, it may be implemented in other shapes, for example, an arc, a semi-circle or a circle surrounding the activation button in other embodiments.

Moreover, as shown in FIG. 1C, the actionable items 104 may include an “add” actionable item (e.g., marked by a “+” (“plus”) sign) and a “delete” actionable item (e.g., marked by a “−” (“minus”) sign) as described herein. In some embodiments, however, each of the “+” (“plus”) and “−” (“minus”) actionable items may be presented on the graphical user interface 100 as a menu item 106 and removed from the display pane 102. In some other embodiments, each of the “+” (“plus”) and “−” (“minus”) actionable items may be presented on the graphical user interface 100 as a menu item 106 and as an actionable item on the display pane 102. In at least one embodiment, the “+” (“plus”) and “−” (“minus”) actionable items may be combined (e.g., “+/−”) and presented on the graphical user interface 100 as a single menu item 106 or as actionable item on the display pane 102.

The positions of the menu items 106 on FIG. 1B and the activation button 108 on FIG. 1C are for illustration purpose only. In various embodiments, the menu items 106 may be positioned anywhere on the graphical user interface 100. For example, in an embodiment of the graphical user interface 100 of FIG. 1C, the activation button 108 may be positioned anywhere along the left side, the right side, the bottom, the top, the four corners of the graphical user interface. Moreover, in an embodiment of the graphical user interface 100 of FIG. 1B, the menu items 106 may be scattered (e.g., as shown in FIG. 1B) or aligned along the top, the bottom, the left side or the right side of the graphical user interface 100. In addition, in some embodiments, each of the menu items 106 on FIG. 1B may be anchored at a respective fixed position on the graphical user interface 100 and cannot be moved. In some other embodiments, each of the menu items 106 may float on the graphical user interface 400. That is, they are not anchored on fixed positions and may be dragged and placed anywhere on the graphical user interface 100 (including on top of the display pane 102). In some embodiments, however, after released from a drag, a menu item 106 may attach itself to a nearest side (e.g., left, right, top, bottom).

For example, a user may use a mouse (or a finger if the display device is a touch screen) by holding a button (or finger) to move and place a respective menu item 106 anywhere on the graphical user interface 100 of FIG. 1B (including on top of the display pane 102).

Furthermore, in some embodiments, the menu items 106, the activation button 108, or both, may be presented on transparent or translucent tiles on the graphical user interface 100. In at least one embodiment, the activation button 108 may be dragged by a user action to be placed anywhere the use want it to be. For example, a user may use a mouse (or a finger if the display device is a touch screen) by holding a button (or finger) to move and place the activation button 108 anywhere on the graphical user interface 100 FIG. 1D (including on top of the display pane 102).

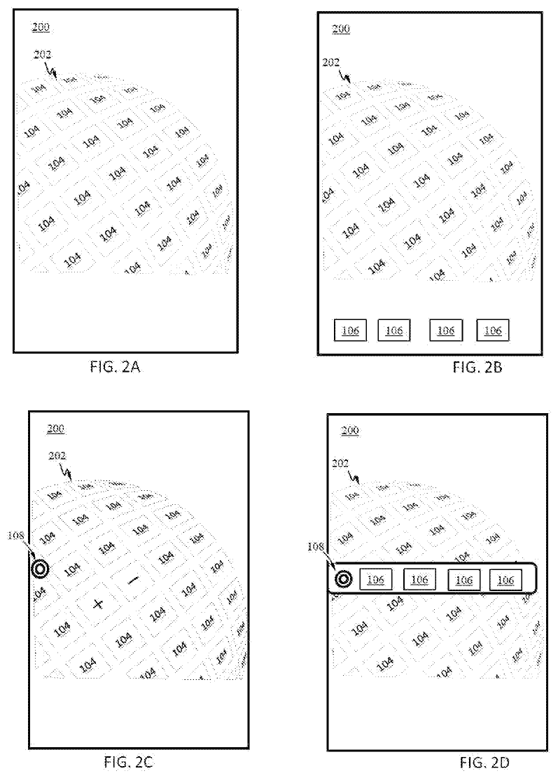

FIG. 2A is a schematic diagram of an exemplary graphical user interface 200 presented on a display device of a computing device. The graphical user interface 200 may be an alternative embodiment of the graphical user interface 100. Instead of showing a full perspective view of a three dimensional object such as the display pane 102 in FIGS. 1A-1D, the graphical user interface 200 may comprise a display penal 202 that may be a partial perspective view of a three dimensional object. The plurality of actionable items 104 shown in the two dimensional display pane 202 may be a subset of the whole set of the actionable items 104 positioned on the surface of the three dimensional object that may be visible in the two dimensional display pane 202 based on a relative position, a relative orientation, or both.

In one embodiment, the display pane 202 may be a partial view of the display pane 102. All features in various embodiments of the display pane 202, including the actionable items 104, the rotational features, grouping of actionable items 104 and visual effects of the display pane 202, may be the same as that of the display pane 102 and described herein. For example, a user may invoke an actionable item 104 shown in the display pane 202, or the three dimensional object may be rotated to cause a currently not shown actionable item to be shown on the display pane 202. In addition, the display pane 202 may also have the see through effect in some embodiments.

FIG. 2B is a schematic diagram of the exemplary graphical user interface 200 according to another embodiment. In addition to the exemplary display pane 202, the graphical user interface 200 of FIG. 2B may comprise one or more menu items 106. These menu items 106 may be the same menu items 106 as shown in FIG. 1B and described herein. Moreover, these menu items 106 may also be hosted on a menu bar which may be activated by an activation button 108 as shown in FIGS. 1C and 1D and described herein. As an example, FIG. 2B shows that the menu items 106 may be aligned and positioned at the bottom of the graphical user interface 200. FIG. 2C is a schematic diagram of an alternative embodiment of the graphical user interface 200. In comparison to FIG. 2B, the one or more menu items 106 may be replaced by a single activation button 108. In operation, for example, a user may click (or tap if the display device is a touch screen) on the activation button 108 and a menu bar may glide or slide open. One example is shown on FIG. 2D, which schematically shows the graphical user interface 200 of FIG. 2C in an operational state that a menu bar with the menu items 106 is displayed. FIGS. 2C and 2D also illustrate that the activation button 108 may be placed anywhere on an embodiment of the graphical user interface 100, such as along the left side of the graphical user interface 200 as an example. Although not shown, the activation button 108 may be dragged and placed anywhere in response to a user action (e.g., holding a button on a mouse or holding a finger on a touch screen). In at least one embodiment, however, after released from a drag, the activation button 108 may attach itself to a nearest side (e.g., left, right, top, bottom). Moreover, as shown in FIG. 2C, on one embodiment of the display pane 202 the actionable items 104 may include an “add” actionable item (e.g., marked by a “+” (“plus”) sign) and a “delete” actionable item (e.g., marked by a “−” (“minus”) sign) as described herein.

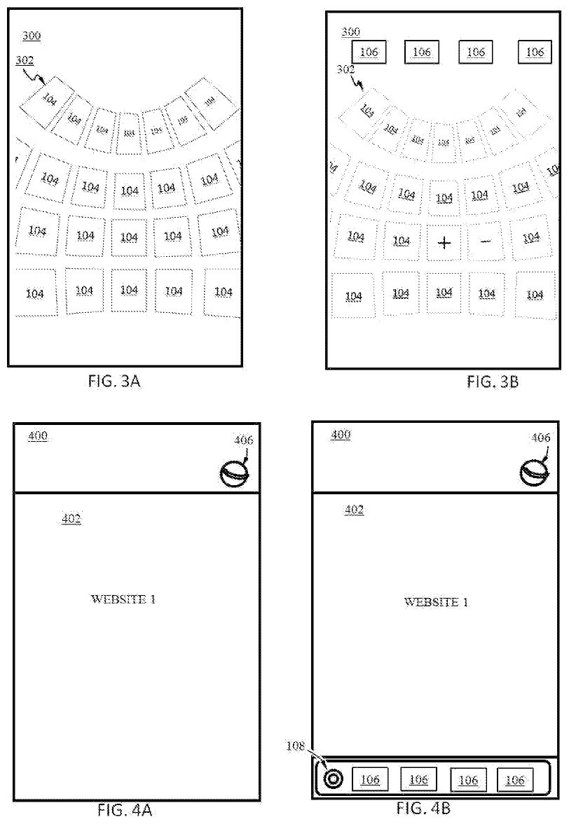

FIG. 3A is a schematic diagram of an exemplary graphical user interface 300 presented on a display device of a computing device. The graphical user interface 300 may be yet another alternative embodiment of the graphical user interfaces 100 and 200. In comparison to the graphical user interface 100 in FIGS. 1A-1D and the graphical user interface 200 in FIGS. 2A-2B, instead of showing a perspective view (e.g., full or partial) of a three dimensional object looking from outside, the graphical user interface 300 may comprise a display penal 302 that may be a view from inside a three dimensional object looking outwards. In one embodiment, the display pane 302 may be similar to a dome view looking up at a curved ceiling. The actionable items 104 and the rotational features of the display pane 302 may be the same as that of the display pane 102 and described herein.

FIG. 3B is a schematic diagram of the exemplary graphical user interface 300 according to another embodiment. In addition to the exemplary display pane 302, the graphical user interface 300 of FIG. 3B may comprise one or more menu items 106. These menu items 106 may be the same menu items 106 as shown in FIG. 1B and described herein. As an example, FIG. 3B shows that the menu items 106 may be aligned and positioned at the top of the graphical user interface 300. Moreover, these menu items 106 may also be hosted on a menu bar which may be activated by an activation button 108 as shown in FIGS. 1C-1D and 2C-2D and described herein. In addition, as shown in FIG. 3B, on one embodiment of the display pane 302 the actionable items 104 may include an “add” actionable item (e.g., marked by a “+” (“plus”) sign) and a “delete” actionable item (e.g., marked by a “−” (“minus”) sign) as described herein.

In at least one embodiment, which one of the graphical user interfaces 100, 200 and 300 to show may be selected by an application setting. For example, one of them may be set as the default, and a setting page may be provided for a user to change to another one. Moreover, in one embodiment, a currently shown graphical user interface (e.g., 100, 200 or 300) may be changed to another one by a swipe of multiple fingers on a touchpad or touch screen. For example, if the graphical user interface 200 is currently shown, a swipe of three fingers to the left may show the graphical user interface 300, and a swipe of three fingers to the right may show the graphical user interface 100.

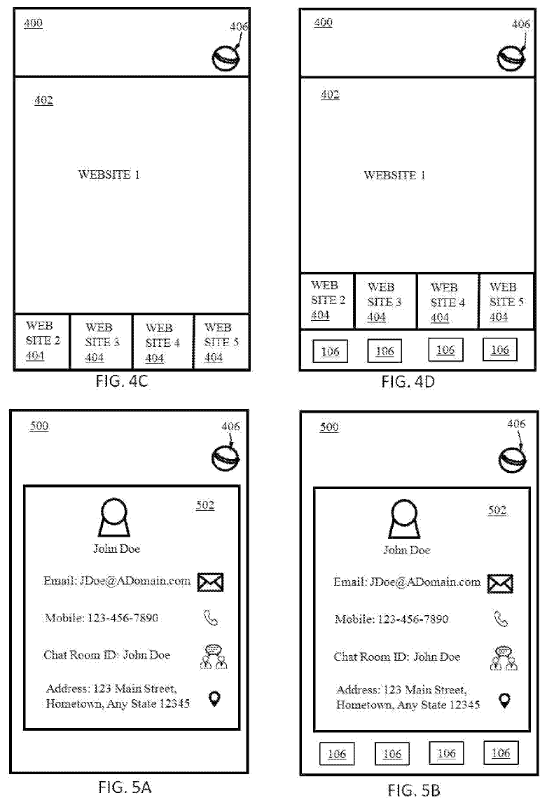

FIG. 4A is a schematic diagram of an exemplary graphical user interface 400 presented on a display device of a computing device. The graphical user interface 400 may be displayed in response to an actionable item 104 of the graphical user interface 100 is invoked. The graphical user interface 400 may comprise a display pane 402, which may display a web page of a website. The graphical user interface 400 may be displayed when an actionable item 104 associated with the website is invoked (on the display pane 102, 202 or 302). The graphical user interface 400 may further comprise an icon 406, which may be a graphical representation of a minimized two dimensional perspective view of a three dimensional object (e.g., the display pane 102, 202, or 302). In one embodiment, the icon 406 may be a special actionable item, such as a button or link, to restore the two dimensional perspective view (e.g., the display pane 102, 202, or 302). Accordingly, in one embodiment, the icon 406 may be referred to as a “Home” button and the graphical user interface 100, 200 or 300 may be referred to as a “Home” screen. In some embodiments, the icon 406 may be anchored at a fixed position on the graphical user interface 400 and cannot be moved. In some other embodiments, the icon 406 may float on the graphical user interface 400. That is, it is not anchored on a fixed position and may be dragged and placed anywhere on the graphical user interface 400. In some embodiments, however, after released from a drag, the icon 406 may attach itself to a nearest side (e.g., left, right, top, bottom).

FIG. 4B is a schematic diagram of the exemplary graphical user interface 400 according to another embodiment. In addition to the display pane 402 and icon 406, the graphical user interface 400 may further comprise an activation button 108 as shown in FIGS. 1C-1D and 2C-2D and described herein. On the graphical user interface 400 of FIG. 4B, the activation button 108 may be in an activated state such that the menu bar with the menu items 106 are shown. As described herein, the menu bar may be retracted, for example, by a click (or tap if the display device is a touch screen) on the activation button 108 on the graphical user interface 400 of FIG. 4B.

FIG. 4C is a schematic diagram of the exemplary graphical user interface 400 according to yet another embodiment. In addition to the display pane 402 and icon 406, the graphical user interface 400 may further comprise a plurality of tabs 404 for websites other than the website opened in the display pane 402. In some embodiments, these other websites may be referred to as secondary websites. For example, when a user invoked an actionable item 104 for a news website, several other news websites may also be opened and represented as the tabs 404. These other websites may be determined based on user's historical usage (e.g., most viewed websites), proximity to the invoked actionable item 104 (e.g., the corresponding actionable items positioned close to the invoked actionable item 104 on the display pane 102, 202 or 302). Thus a user may quickly switch over to one of the other websites (e.g., by a click or tap on one of the tabs 404) without going back to the display pane 102, 202 or 302 to invoke the corresponding actionable item 104. The criteria for choosing which secondary websites to open in the tabs 404 may be numerous and not limited by the examples described herein. In some embodiments, the criteria may be a configurable setting that may be configured by invoking the “settings” menu.

In one embodiment, the currently shown website (e.g., the website 1 shown in the display pane 402) may also have a tab among the tabs 404 (e.g., between the tab 404 for the website 2 and the tab 404 for the website 3). A user may switch to another website by either clicking or tapping on one of the tabs 404 or swipe a finger to the left or right on a touch screen. For example, if the tab for the website 1 is positioned between the tab for the website 2 and the tab for the website 3, a swipe to the left may bring out an opened website 3 and a swipe to the right may bring out an opened website 2 to be shown in the display pane 402. In some embodiments, the tab representing the currently shown website may be marked (e.g., highlighted) to distinguish from other tabs 404.

FIG. 4D is a schematic diagram of the exemplary graphical user interface 400 according to yet another embodiment. In comparison to the graphical user interface 400 shown on FIG. 1C, the graphical user interface 400 of FIG. 4D may further comprise a plurality of menu items 106 as described herein. In at least one embodiment, the menu items 106 may be put on a menu bar that may be activated/retracted by an activation button 108 as shown in FIGS. 1C-1D and 2C-2D and described herein.

In some embodiments, the graphical user interface 400 may be displayed with an animation in which the display pane 102 of the graphical user interface 100 may shrink into the icon 406, for example, with a series of display panes 102 that each is smaller than an earlier one and finally becomes the icon 406.

FIG. 5A is a schematic diagram of the exemplary graphical user interface 500 according to one embodiment. The graphical user interface 500 may comprise a detailed information display pane 502 for an individual. The graphical user interface 500 may be displayed when an actionable item 104 associated with an individual on a contact list is invoked (on the display pane 102, 202 or 302). The detailed information display pane 502 may show detailed information for the individual, which may include, but not limited to, an email address, a phone number, a chat room ID, and an address. In at least one embodiment, each piece of detailed information may have an associated button (e.g., an icon) to directly invoke a corresponding application. For example, a click (or tap if the display device is a touch screen) on an email button may open an email function or application, on a phone button may open a phone application to dial the number, on a chat room ID may open a chat application, on an address button may open a map. Moreover, in some embodiments, one or more pieces of the detailed information may be a link itself that when clicked (or tapped if the display device is a touch screen). The graphical user interface 500 may further comprise an icon 406 as shown in FIG. 4A-4D and described herein.

In one embodiment, in addition to the display pane 502 and icon 406, the graphical user interface 500 may further comprise a plurality of tabs for other contacts sharing a common characteristic of the contact currently been shown in the display pane 502. In some embodiments, these other contacts may be referred to as similar contacts. For example, when a user invoked an actionable item 104 for a contact named “John Doe,” several other contacts may also be opened and represented as the tabs at the bottom of the display 500. These other contacts may be determined based on first name, last name, social relationship, a proximity to the invoked actionable item 104 (e.g., the other opened contacts correspond to actionable items positioned close to the invoked actionable item 104 on the display pane 102, 202 or 302). For example, some other contacts named John or Doe or John Doe; or if John Doe is a classmate, some other classmates; or if John Doe is a relative, some other relatives; or if John Doe is a colleague or former colleague, some other colleagues or former colleagues. Thus a user may quickly switch over to one of the other contacts (e.g., by a click or tap on one of the tabs) without going back to the display pane 102, 202 or 302 to invoke the corresponding actionable item 104. The criteria for choosing which similar contacts to open in the tabs may be numerous and not limited by the examples described herein. In some embodiment, the criteria may be a configurable setting that may be configured by invoking the “settings” menu.

In one embodiment, the currently shown contact (e.g., John Doe shown in the display pane 502) may also have a tab among the tabs for those similar contacts and a user may switch to another contact by either clicking or tapping on one of the tabs or swipe a finger to the left or right on a touch screen. For example, if the tab for John Doe is positioned between the tab for Jane Doe and the tab for John Smith, a swipe to the left may bring out a detailed information display for John Smith and a swipe to the right may bring out a detailed information display for Jane Doe. In some embodiments, the tab representing the currently shown contact may be marked (e.g., highlighted) to distinguish from tabs for the similar contacts.

FIG. 5B is a schematic diagram of the exemplary graphical user interface 500 according to another embodiment. In comparison to the graphical user interface 500 shown on FIG. 5A, the graphical user interface 500 of FIG. 5B may further comprise a plurality of menu items 106 as shown and described herein. In at least one embodiment, the menu items 106 may be put on a menu bar that may be activated/retracted by an activation button 108 as shown in FIGS. 1C-1D and 2C-2D and described herein.

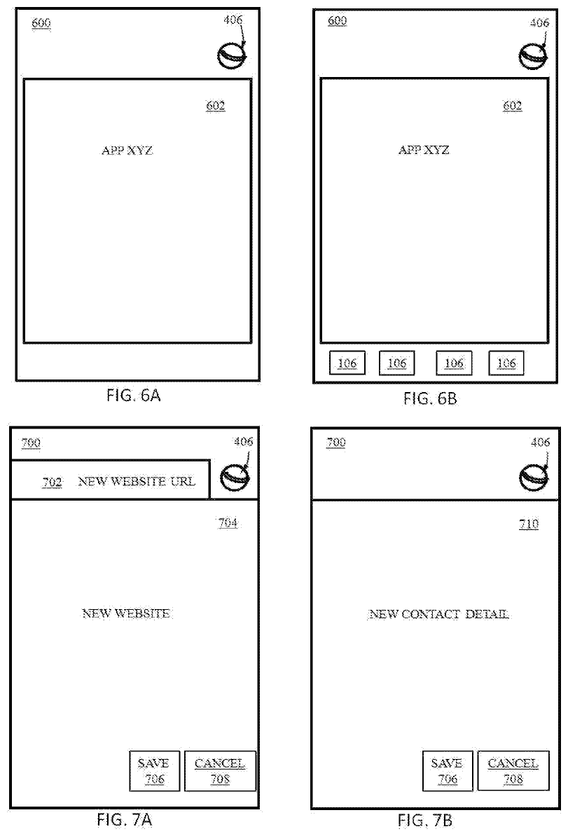

FIG. 6A is a schematic diagram of the exemplary graphical user interface 600 according to one embodiment. The graphical user interface 600 may comprise an application display pane 602. The graphical user interface 500 may be displayed when an actionable item 104 associated with an application (e.g., APP XYZ) is invoked (on the display pane 102, 202 or 302). In one embodiment, the application (e.g., APP XYZ) may be one of a plurality of applications installed on the computing device and launched when an actionable item 104 associated with the application is invoked (e.g., on the display pane 102, 202, or 302). The application may be, for example, an email application, a game application, an office automation application, a shopping application, a chat application, a photo album application, or any application that may be installed on the computing device. In another embodiment, the application (e.g., APP XYZ) may be one functional module as part of the application (e.g., an email module, a game module, an OA module, a shopping module, a chat module, a photo album module) or any functional module implemented by the application) that displays the graphical user interface 100, 200 or 300. The graphical user interface 600 may further comprise an icon 406 as shown in FIG. 4A-4D and described herein.

FIG. 6B is a schematic diagram of the exemplary graphical user interface 600 according to another embodiment. In comparison to the graphical user interface 600 shown on FIG. 6A, the graphical user interface 600 of FIG. 6B may further comprise a plurality of menu items 106 as shown and described herein. In at least one embodiment, the menu items 106 may be put on a menu bar that may be activated/retracted by an activation button 108 as shown in FIGS. 1C-1D and 2C-2D and described herein.

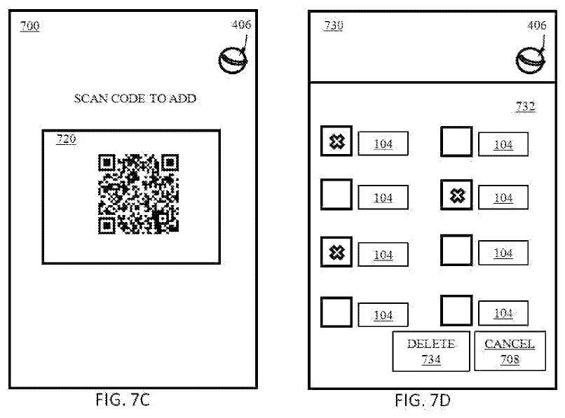

FIG. 7A is a schematic diagram of the exemplary graphical user interface 700 according to one embodiment. The graphical user interface 700 may comprise an input box 702, a display pane 704 and an icon 406. The graphical user interface 700 may be displayed when a “+” (“plus”) actionable item on the graphical user interface 100, 200 or 300 may be selected (e.g., clicked or tapped) to enter a new information item, such as a website. The input box 702 may be used to input a new website address (e.g., uniform resource locator or Internet Protocol (IP) address). In a desktop computer, for example, once the new website address is entered, pressing an “Enter” key on a keyboard may load a webpage of the corresponding website in the display pane 704. In a pad device or a mobile device, the graphical user interface 700 may be displayed on a touch screen. When the focus is on the input box 702, a keyboard may emerge on the touch screen and the keyboard may comprise a “GO” or “Enter” button to load the website. The icon 406 may be the same as shown in FIG. 4A-4D and described herein. The graphical user interface 700 may further comprise a “SAVE” button 706 and a “CANCEL” button 708. If the “SAVE” button is clicked (or tapped), the graphical user interface 700 may be replaced with the graphical user interface 100, 200 or 300, with a new actionable item 104 corresponding to the newly added information item (e.g., the new website). If the “CANCEL” button is clicked (or tapped), the graphical user interface 700 may be replaced with the graphical user interface 100, 200 or 300 with no changes to the actionable items 104.

FIG. 7B is a schematic diagram of the exemplary graphical user interface 700 according to another embodiment. The graphical user interface 700 may be displayed when a “+” (“plus”) actionable item on the graphical user interface 100, 200 or 300 may be selected (e.g., clicked or tapped) to enter a new information item, such as a contact. The graphical user interface 700 of FIG. 7B may comprise an input panel 710 for inputting detailed information for the new contact in addition to the icon 406. In one embodiment, the input panel 710 may comprise a plurality of input boxes for entering new pieces of information for the new contact. In another embodiment, the plurality of input boxes may be presented in a series of input screens. The graphical user interface 700 may also comprise a “SAVE” button 706 and a “CANCEL” button 708 as shown in FIG. 7A and described herein.

In some embodiments, the “+” (“plus”) actionable item on the graphical user interface 100, 200 or 300 may be selected (e.g., clicked or tapped) to add a new application or a new functional module to the information items list for the display pane 102, 202 or 302. The new application of the new functional module may be locally stored (e.g., in the hard drive of the computing device) or may be downloaded from a network (e.g., local area network (LAN), wide area network (WAN) or the Internet. If the new application or new functional module is locally stored or a network, one embodiment of the graphical user interface 700 may show a file system exploration user interface to let a user locate the new application or new functional module. In some embodiments, the new application or new functional module may be located using an address and an address input box may be presented on the graphical user interface 700. In at least one embodiment, the new application or new functional module may be downloaded from an address by scanning a barcode (e.g., Universal Product Code (UPC) code, or Quick Response (QR) code). FIG. 7C is a schematic diagram of the exemplary graphical user interface 700 according to one embodiment that shows a camera view 720 in addition to an icon 406. A user may operate a scanning device or a camera of the computing device to scan a bar code to locate the new application or new functional module. In some embodiments, once the code is scanned, a prompt may be used to get user confirmation to download and add the new application or new functional module. In at least one embodiment, the barcode scanning graphical user interface 700 of FIG. 7C may also be used for adding a new contact or adding a new website, in addition to or in place of the graphical user interface 700 of FIGS. 7A and 7B.

It should be noted that in some embodiments, a transitional graphical user interface comprising a prompt of several input options for entering the new information item may be presented on the display device when a “+” (“plus”) actionable item on the graphical user interface 100, 200 or 300 may be selected (e.g., clicked or tapped). The input options may include, but not limited to, using an input box (e.g., for entering an address), using an input panel (e.g., for entering detailed information for an individual), using file system exploration, or scanning a code, etc. Although not shown in FIGS. 7A-7C, in some embodiments, one or more pieces of information entered by a user may be used to group the new information item, for example, a news website may be grouped with news website, a classmate may be grouped with other classmates, etc. The corresponding new actionable item 104 may be presented in the same area of the display pane 102 as other actionable items 104 of the same group. And the grouping and position information may be preserved as described herein.

In some embodiments, the “−” (“minus”) actionable item on the graphical user interface 100, 200 or 300 may be selected (e.g., clicked or tapped) to delete an actionable item 104. Deleting the actionable item 104 may also delete the underlying information item (e.g., a file, an application, a contact) from the storage of the computing device (e.g., database, memory or hard drive). FIG. 7D is a schematic diagram of an exemplary graphical user interface 730 according to one embodiment. The graphical user interface 730 may comprise a list panel 732, the icon 406, a “DELETE” button 734 and the “CANCEL” button 708. The list panel 732 may show a list of actionable items 104 (or their underlying information items) currently assigned to the three dimensional object. A selection box (e.g., a check box) may be associated with each actionable item 104 and the “DELETE” button may be used to delete the selected actionable items. Although not shown, in one embodiment, the list panel 732 may include scrolling bars (e.g., up and down, left and right, or both) to display all actionable items that may be deleted. In an alternative embodiment, an actionable item 104 may have an associated delete button such that the actionable item 104 may be deleted by selecting its associated delete button. In such an alternative embodiment, and the “DELETE” button 734 and “CANCEL” button 708 may not be necessary.

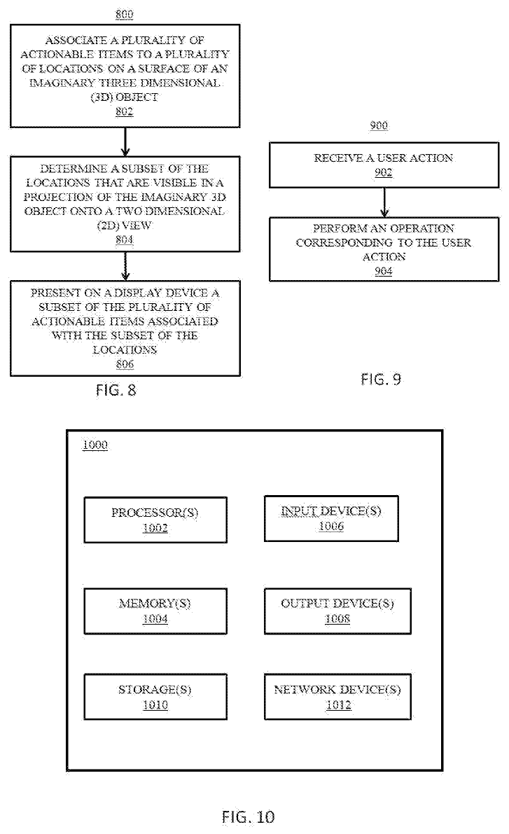

FIG. 8 schematically shows a flowchart of an exemplary method 800 for populating a graphical user interface of a computing device. The method 800 may be implemented using software (e.g., executable by a computer processor (CPU, GPU, or both)), hardware (e.g., a field-programmable gate array (FPGA) or an application-specific IC (ASIC), firmware, or any suitable combination of the three. In the example, at block 802, a plurality of actionable items may be associated to a plurality of locations on a surface of an imaginary three dimensional (3D) object. For example, the plurality of actionable items may be commands, buttons, links or combinations thereof, for opening websites, launching applications, opening files or folders, or opening detailed information pages for contacts.

The plurality of actionable items may be assigned to the plurality of locations in a variety of ways in different embodiments. For example, in one embodiment, the plurality of actionable items may be organized in an order (e.g., alphabetical, position on a desktop, timestamp of when an application is installed) and the assignment to associated plurality of locations may be performed according to that order. In another example, the plurality of actionable items may be organized in different groups according to some criteria and each group assigned to different regions. For example, as described herein, the plurality of actionable items may correspond to websites, detailed information for contacts, applications, application modules, files, or folders, which may be grouped by some criteria, such as by subjects, by social connection characteristic, by language, etc. In one embodiment, the 3D object may be a globe and each group of corresponding actionable items may be assigned to one respective region of the globe, for example, one respective spherical lune, spherical triangle, or in a region of neighboring tiles (e.g., n by m tiles, n and m may be integers for latitude and longitude respectively).

At block 804, it may be determined that a subset of the locations may be visible in a projection of the imaginary 3D object onto a two dimensional (2D) view. In one embodiment, the 2D view may be a perspective 2D view of the imaginary 3D object based on a relative orientation, a relative position or both. For example, the 3D object may only have a portion facing a view point and the perspective two dimensional view may be generated based on what falls into a view from this view point (e.g., using a camera facing the three dimensional object to capture what falls into the camera's view).

At block 806, a subset of the plurality of actionable items associated with the subset of the locations may be presented on a display device. In one embodiment, each of the complete set of the plurality of actionable items may be presented and accessible by rotating the 3D object.

FIG. 9 schematically shows a flowchart of an exemplary method 900 for operating a computing device using a graphical user interface according an embodiment. The method 900 may be implemented using software (e.g., executable by a computer processor (CPU, GPU, or both)), hardware (e.g., a field-programmable gate array (FPGA) or an application-specific IC (ASIC), firmware, or any suitable combination of the three. In the example, at block 902, a user action may be received. For example, a user action may be received from an input device to act on a graphical user interface. The graphical user interface may be, for example, one of the graphical user interfaces 100, 200, 300, 400, 500, 600, 700 and 730. At block 904, an operation corresponding to the user action may be performed. For example, the user action may be a single click or a double click of a mouse (or a single tap or double tap on a touch screen) on an actionable item 104, a menu item 106, or the activation button 108, and the corresponding operation may be invoking a corresponding function or launching the corresponding information session, such as, opening a website, opening a detailed information page for an individual, opening a file or folder, launching an application, adding a new website, adding a new contact, downloading a new application or functional module, deleting an existing actionable item, changing a setting, adjusting the graphical user interface (e.g., changing the rotation speed, changing a theme, changing a opaqueness of tiles/gaps), etc. Moreover, the user action may be a drag and drop of an actionable item 104, a menu item 106, or the activation button 108, and the corresponding operation may be to change the position of the respective item.

In some embodiments, the user action may be directed to an actionable item 104, in addition to one information session associated with the actionable item 104 receiving the user action, several other information sessions may also be launched. For example, while the information session associated with the actionable item 104 receiving the user action may be shown in the graphical user interface, other launched information sessions may be accessed either via a tab (e.g., multiple tabs corresponding to the launched information sessions may be shown at the top or bottom for easy switch) or by left or right swipe of a finger. In one embodiment, a strip of icons or tabs may be shown in response to a left or right of a finger on a touch screen to indicate what's on the left or right of the shown information session. The various examples are for illustration only and any other suitable user actions and corresponding operations may be implemented.

### Exemplary Computing Device

The described embodiments, techniques, and technologies can be performed by software and/or hardware of a computing device. Suitable computing devices may include server computers, desktop computers, laptop computers, notebook computers, netbooks, tablet devices, mobile devices (e.g., cell phone, smartphone, handheld computer, Personal Digital Assistant (PDA), etc.), and other types of computing devices (e.g., devices such as televisions, media players, or other types of entertainment devices that comprise computing capabilities such as playing audio/video and/or accessing network). The display device for displaying the various embodiments of the graphical user interfaces may be, for example, a computer monitor, a television, a touch screen, or any suitable displaying device.

FIG. 10 is a block diagram depicting an exemplary computing device 1000 including a variety of hardware components. Any of the disclosed embodiments may be implemented by or using such a device. The computing device 1000 may comprise one or more processors 1002, a memory 1004, one or more input devices 1006, one or more output devices 1008, one or more storages 1010 and one or more network devices 1012. The one or more processors 1002 may include one or more of a central processing unit (CPU), a graphics processing unit (GPU), microcontroller, microprocessor, FPGA, ASIC and other control and processing logic circuitry. The memory 1004 may be non-transitory computer readable storage media, which may be volatile memory (e.g., registers, cache, RAM), non-volatile memory (e.g., ROM, EEPROM, flash memory, etc.), or some combination of the two.

The memory 1004 may be used for storing data and/or code for running an operating system and applications. Example data may include web pages, text, images, sound files, video data, or other data sets stored at the computing device 100, or to be sent to and/or received from one or more network servers or other devices via one or more wired or wireless networks. In one embodiment, the one or more processors 1002 may be configured to execute computer-executable instructions of software stored in the memory 1004. The software may implement the techniques described herein such as the methods 800, 900, animation of any components of the graphical user interface and any other operations described herein (e.g., rotating the three dimensional object, grouping information items, arranging/re-arranging positions of the actionable items, adding new information items, deleting information/actionable items, preserving position information for the actionable items, etc.). In some embodiment, the software implementing the techniques described herein may be part of an operating system or an application. The application may be an email application, a contact manager, a web browser, a messaging application, a shopping application, or any other computing application. In a multi-processing system, multiple processors may execute computer-executable instructions to increase processing power and as such, multiple processors can be running simultaneously.

The one or more storages 1010 may be removable or non-removable, and may include magnetic disks, magnetic tapes or cassettes, solid state drives (SSDs), hybrid hard drives, CD-ROMs, CD-RWs, DVDs, or any other tangible storage medium which can be used to store information and which can be accessed within the computing device 1000. The storage 1010 may also stores computer-executable instructions and data for the software technologies described herein.

The input device(s) 1006 may be a touch input device (e.g., a pop up keyboard), keypad, mouse, pen, or trackball, a voice input device, a scanning device, a camera or another device, that provides input to the computing device 1000. In addition, the input device(s) 1006 may include a sound card or similar device that accepts audio input in analog or digital form, or a CD-ROM reader that provides audio samples to the computing device 1000. The output device(s) 1008 may be a display (e.g., a touch screen, or an output port for connecting a monitor), printer, speaker, CD-writer, or another device that provides output from the computing device 1000. Other possible output devices may include piezoelectric or other haptic output devices. Some devices can serve more than one input/output function. For example, a touchscreen may be both an input device and an output device. The network devices 1012 may include a network interface card that enable communication over a communication medium (e.g., a connecting network) to another computing entity. The communication medium may convey information such as computer-executable instructions and data. In one embodiment, an interconnection mechanism (not shown) such as a bus, a controller, or a network, may interconnect the components of the computing device 1000. Moreover, the illustrated components of the computing device 1000 are not required or all-inclusive, as any components can be deleted and other components can be added.

Any of the disclosed methods and operations can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computing device (e.g., any suitable commercially available computer or mobile device) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C/C++, Java, Perl, JavaScript, HTML or any other suitable computer language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication network. Such suitable communication network may include, for example, the Internet, the World Wide Web, an intranet, software applications, cable (including fiber optic cable), magnetic communications, electromagnetic communications (including RF, microwave, and infrared communications), electronic communications, or other such communication means.

The present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

Moreover, although the operations of some of the disclosed methods may be described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method, comprising:
associating a plurality of actionable items to a plurality of locations on a surface of an imaginary three dimensional (3D) object;
determining, based on a relative orientation and/or a relative position of the imaginary 3D object with respect to a two dimensional (2D) view, a subset of the locations to be visible in a projection of the imaginary 3D object onto the 2D view, and
presenting a subset of the plurality of actionable items associated with the subset of the locations on a display device.

2. The method of claim 1, further comprising:
receiving a user action to spin the imaginary 3D object; and
rotating the imaginary 3D object to bring one or more of the plurality of actionable items that do not belong to the subset of the plurality of actionable items into the 2D view.

3. The method of claim 2, wherein the display device is a touch screen of a mobile device;
wherein the user action is a swipe of a finger on the touch screen.

4. (canceled)

5. The method of claim 1, further comprising, according to a configuration setting, rotating the imaginary 3D object to bring one or more of the plurality of actionable items that do not belong to the subset of the actionable item into the 2D view.

6. The method of claim 1, further comprising:
receiving a user action on an actionable item of the plurality of actionable items; and
launching an information session associated with the actionable item, wherein the information session is one of an opened website, an opened detailed page for a contact, a launched application, an opened file, an opened folder and a launched application module.

7. The method of claim 6, wherein the display device is a touch screen of a mobile device, and the user action is a tap or a double tap on the actionable item.

8. The method of claim 6, further comprising presenting a home button for returning to showing the 2D view.

9. The method of claim 6, further comprising:
launching a plurality of information sessions associated with select actionable items sharing a common characteristic with the actionable item receiving the user action, and
presenting tabs to represent the plurality of information sessions, wherein the common characteristic is a configurable setting.

10. The method of claim 1, further comprising:
receiving a user action to drag and drop an actionable item; and
adjusting a position of the actionable item dragged and dropped in the user action to a new position.

11. The method of claim 10, wherein the new position is on the 2D view and in close proximity to one or more actionable items sharing a common characteristic of the actionable item dragged and dropped in the user action.

12. The method of claim 10, wherein the new position is outside of the 2D view.

13. The method of claim 10, wherein the display device is a touch screen of a mobile device and the user action is pressing and holding a finger to move the actionable item.

14. The method of claim 10, wherein the display device is a monitor for a computing device and the user action is received from a mouse coupled to the computing device.

15. The method of claim 1, further comprising:
grouping at least some of the plurality of actionable items to form a group of actionable items; and
positioning the group of actionable items in one region of the imaginary 3D object.

16. The method of claim 1, wherein the 2D view is a full perspective view of the imaginary 3D object looking from a view point outside of the imaginary 3D object.

17. The method of claim 1, wherein the 2D view is a partial perspective view of the imaginary 3D object looking from a view point outside of the imaginary 3D object.

18. The method of claim 1, wherein the 2D view is a perspective view of the imaginary 3D object looking from a view point inside of the imaginary 3D object.

19. The method of claim 1, further comprising:
presenting an activation button on the display device;
receiving a user action to activate the activation button; and
presenting one or more menu items in response to the user action.

20. A computing device comprising a processor and a memory, the memory storing computer-executable instructions that when executed by the processor cause the computing device to perform a method, the method comprising:
associating a plurality of actionable items to a plurality of locations on a surface of an imaginary three dimensional (3D) object;
determining, based on a relative orientation and/or a relative position of the imaginary 3D object with respect to a two dimensional (2D) view a subset of the locations to be visible in a projection of the imaginary 3D object onto the 2D view; and
presenting on a display device a subset of the plurality of actionable items associated with the subset of the locations.

21-38. (canceled)

39. A non-transitory computer readable storage media encoded with software comprising computer executable instructions and when the software is executed by a computing processor cause the computing processor to perform a method, the method comprising:
associating a plurality of actionable items to a plurality of locations on a surface of an imaginary three dimensional (3D) object;
determining, based on a relative orientation and/or a relative position of the imaginary 3D object with respect to a two dimensional (2D) view, a subset of the locations to be visible in a projection of the imaginary 3D object onto the 2D view; and
presenting on a display device a subset of the plurality of actionable items associated with the subset of the locations.

40-45. (canceled)
